(19) United States
(12) Patent Application Publication
(10) Pub. No.: US 2001/0032246 A1
(43) Pub. Date: Oct. 18, 2001

(54) Method and system for creating and sending a video e-mail

(76) Inventors: Anthony James Fardella, Pittsburg, CA (US); Thomas Mason Miller, Reston, VA (US)

Correspondence Address: Mitchell B. Wasson, Hoffman Wasson & Gitler PC, 2361 Jefferson Davis Highway - Suite 522, Arlington, VA, 22202, US

(21) Appl. No.: 09/754,335

(22) Filed: Jan. 5, 2001

Related U.S. Application Data
(60) Provisional application No. 60/174,594, filed on Jan. 5, 2000.

(51) Int. Cl. G06F 15/16

(52) U.S. Cl. 709/206

(57) ABSTRACT

A method and system for composing and sending a video e-mail from a user to a receiver. A video source, such as a digital camera is used to take still or moving pictures which would be stored in the hard drive of the sender's personal computer. A central web server is contacted by the sender and the sender is then provided with a unique number to be associated with the video e-mail. At this point, the video e-mail is sent to the central server. The receiver is contacted indicating that a video e-mail has been sent to the receiver. The receiver would then contact the central server which would then transmit the video e-mail to the receiver to be viewed on the web browser of the receiver's personal computer.

### CROSS-REFERENCE TO RELATED APPLICATION

Pursuant to 35 U.S.C. §119(e), this application claims a priority benefit of provisional patent application Ser. No. 60/174,594, filed Jan. 5, 2000.

### FIELD OF THE INVENTION

The present invention is directed to a method and system for constructing and sending video e-mails.

### BACKGROUND OF THE INVENTION

Since time immemorial, man has always endeavored to develop better and more efficient ways of communicating with one another. Different types of technology have been introduced allowing varying modes of communication to bring the world closer together. After language was developed, people exchanged news chiefly by word of mouth. Various individuals or couriers have carried spoken messages over long distances as was true in the Plains of Marathon. People also employed drum beats, fires and smoke signals to communicate with one another. Once writing was developed, the chief means of long distance communications was the written word. Businesses hired professional messengers who carried letters on foot, on horseback or by ship. However, as can be appreciated, the time it would take to deliver these written messages could be quite long such as when the messages were transported over the high seas. When more efficient means of communications were developed such as the use of the telegraph, the time that it would take to send a message from one point to a far distance point was greatly diminished.

Communication was further aided by the invention of photography such that the written word can be accompanied and amplified by a permanent photograph. The development of television also enhanced communication between the originating television program and a mass audience. Unfortunately, as can be appreciated, the invention of television itself did not enhance the ability of individuals to communicate on a one-to-one basis.

The ability of one individual to communicate with another individual in a speedy manner was enhanced by the development of the computer in conjunction with the internet. This type of technology allowed an individual to instantly send messages to one another utilizing e-mail. While this use of email was beneficial in allowing individuals to communicate with one another using the written word, it was thought that this communication could be enhanced by allowing the individual to incorporate the written word with a visual still or moving picture. This type of technology is illustrated in U.S. Pat. No. 6,014,689, issued to Budge et al. This patent illustrates an email system with a video e-mail player. Audio and video components of a message are recorded, encoded and combined into a video message file which is sent to a recipient over conventional communications networks in the form of a video email. Unfortunately, if this video e-mail is sent directly from a first computer to a second computer, the downloading of the video e-mail in the second computer would be time-consuming and would utilize a large portion of that second computer's memory.

Similarly, U.S. Pat. No. 5,557,320, issued to Krebs illustrates a video mail delivery system in which a sender-subscriber communicates with a network provider system. The network provider system as illustrated in FIG. 4 would prompt the sender-subscriber for various information including the receiver's names and addresses of the video mail. The network provider system would then determine the appropriate time to transmit the bulk data to the receiver. As was true with respect to the Budge et al patent, once the video e-mail is delivered to the receiver, precious memory space would be lost in the receiver's computer for other purposes.

### SUMMARY OF THE INVENTION

The deficiencies of the prior art are addressed by the present invention which is directed to a method and system for allowing a first individual to prepare and send a still or video message with or without a text or audio message to a second individual. A video camera is provided at a central location, such as a kiosk or is attached to the first individual's personal computer. Once the video message or e-mail is composed by the first individual, a message is then sent to a central server. The central server would then e-mail a message to the sender including a unique message number to be associated with the video e-mail. The sender would then upload the video e-mail to the central server. At this point, the central server would e-mail a message to the receiver, notifying the receiver of the existence of the video e-mail. Thereafter, when the receiver wishes to view the video, a connection is made between the central server and the receiver's personal computer, thereby allowing the video message to be viewed through a web browser provided on the receiver's personal computer.

These and other aspects of the present invention will become apparent to those skilled in the art after a reading of the following description of the preferred embodiments when considered with the drawings.

### BRIEF DESCRIPTION OF THE DRAWINGS

FIGS. 1 and 2 are block diagrams showing the components of the present invention;

FIG. 3 is a block diagram showing a method for delivering a video e-mail; and

FIG. 4 is an example of a URL message.

### DESCRIPTION OF THE PREFERRED EMBODIMENTS

The drawings are for the purpose of describing preferred embodiments of the present invention and are not intended to limit the present invention. Like components are represented by the same reference numeral.

The system and method of the present invention (Majikam™) system would allow an individual to generate moving and/or still images from a video source, such as a digital camera associated with a sender's personal computer or a stand alone kiosk. The produced video images in the form of a video e-mail can be utilized with or without text messages and with or without audio messages. The audio message would be generated by a microphone associated with the digital camera. Once a message is generated, various information including e-mail addresses among other information would be associated with the video e-mail. Once the video e-mail was completed, it would be stored on the hard drive of the sender's personal computer or kiosk. A message would then be sent to a central web server. It is important to note that at this point, the video e-mail resides in the central web server and not the receiver's personal computer. Once the receiver wishes to view the video e-mail, the receiver would contact the central web server by clicking a particular icon on the personal computer screen of the receiver. The central web server would respond to this request by searching its database for the proper information and then generate a web page including the video message along with any accompanying audio or textual message. This web page would then be transmitted to the receiver's personal computer for viewing over a web browser associated with the receiver's personal computer.

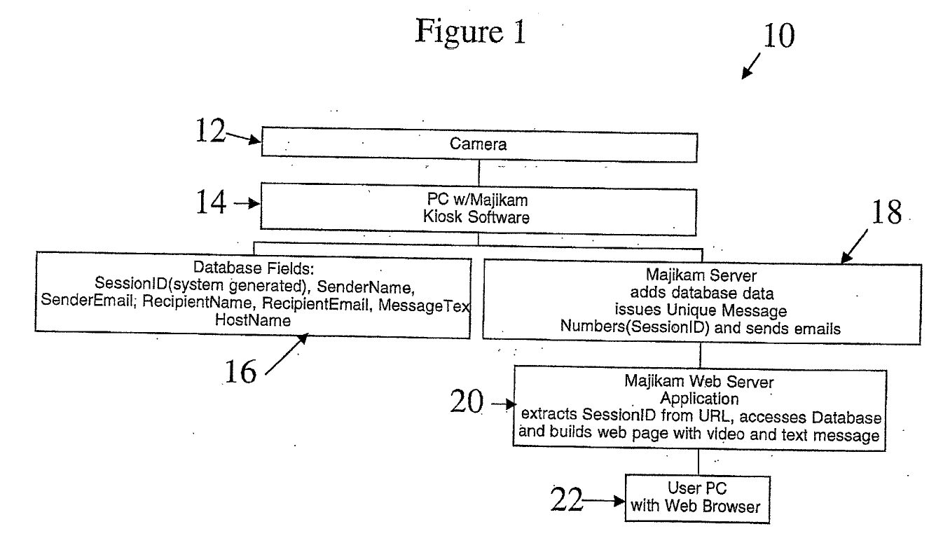

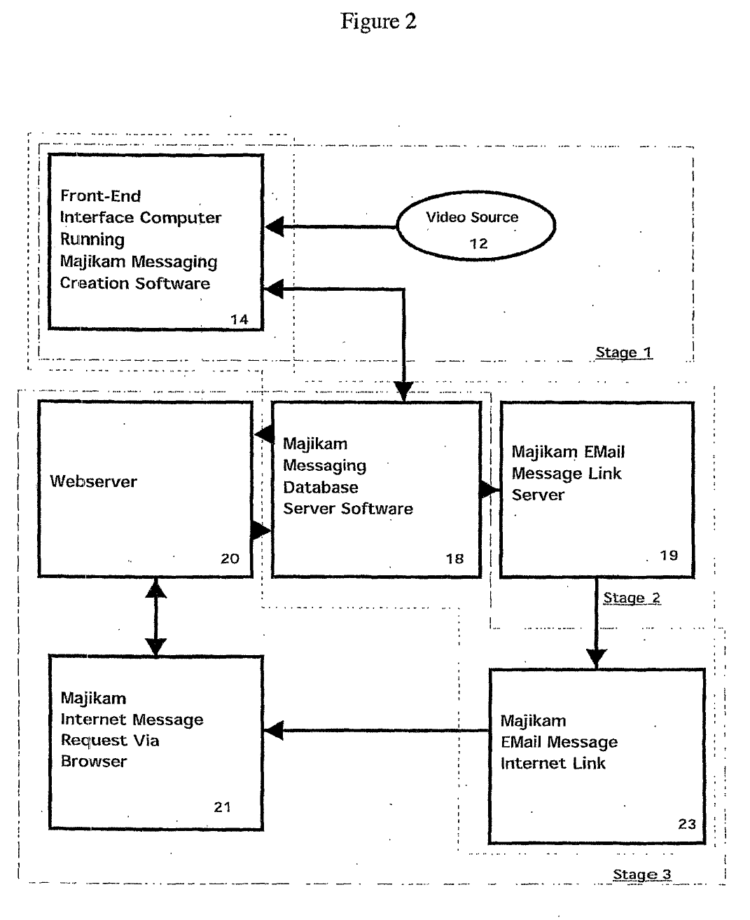

FIGS. 1 and 2 illustrate the major components 10 of the present invention. These components include a video source, such as a digital camera 12 for capturing either a moving or still video image, or both. This generated video image is then saved on the hard drive of the sender's personal computer 14, equipped with the appropriate software (Majikam™ kiosk software) for processing this information and then putting it in a form for transmission to a central server (Majikam™ server) 18.

The Majikam™ kiosk software would prompt the sender to provide information which would accompany the video e-mail. This information includes but is not limited to the sender's name, the sender's e-mail, the receiver's name, the receiver's e-mail and a textual message as illustrated in reference numeral 16. The host name of the Majikam™ server would be automatically included in this additional information. The Majikam™ server 18 would receive a communication from the personal computer or kiosk 14 utilizing the Majikam™ kiosk software. The central server would then add database data including a unique message number to the information supplied by the sender. The database data would also include the internet host name of the server, a user name for log in to the web server, a password for log in to the web server and the location in which to store the video e-mail. A message is then sent back to the sender's personal computer 14 which would allow the Majikam™ kiosk software to rename the video with the server-assigned name and then would upload all of this information into the Majikam™ server's 18 database. The Majikam™ server would also send an e-mail 19, 23 (see FIG. 2) to the receiver indicating that a video e-mail has been sent and is ready for review to the receiver. At this point, it is noted that the video e-mail is stored in the Majikam™ server's database, but is not stored at the present time with the receiver's personal computer 22.

The e-mail received by the receiver's personal computer 22 would include a uniform resource locator (URL) so that the receiver can retrieve their particular video e-mail.

To receive the video e-mail, the user need only click on the URL link and open their message in a web browser as shown by 21. The web browser will open this message and display the video content, along with any textual message. Additionally, if an audio message accompanies the video e-mail, this audio message will be played at the present time.

When the user clicks on the URL, the Majikam™ web server database 18 (located at the same location as the Majikam™ server 20 or at a different location) would extract a session identification from the URL, would access the database and build the web page with the video, textual and if provided, audio message which would be displayed on the web browser of the receiver's personal computer at 22.

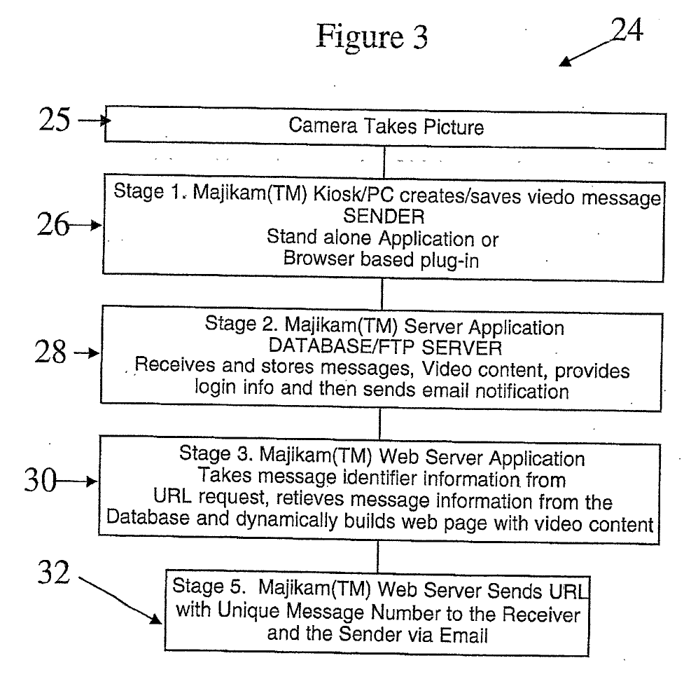

FIG. 3 illustrates the method of the present invention 24 utilizing the components described with respect to FIGS. 1 and 2. Initially, a picture is taken utilizing a video source such as a digital camera at step 25. This picture could either be a still photograph or a moving picture. The video is stored in a temporary file at the Majikam™ kiosk or a personal computer shown at step 26. The sender would then enter information such as their own name, e-mail address, a textual message, as well as the name and the e-mail address for the intended receiver. Furthermore, an audio message could also be added. It is noted that only the receiver's e-mail address is required and the additional information not necessarily needed. The sending device such as the Majikam™ kiosk or personal computer is then connected to the Majikam™ database provided at the Majikam™ server as shown by step 28. It is important to note that the video e-mail is not sent to the Majikam™ server at step 28 but merely the identifying information as noted hereinabove. The Majikam™ database software would then return to the sending computer a unique message number along with additional information as previously described. This number is then used by the sending computer to name the temporary video file. Once named, this file is uploaded to the Majikam™ web server application at step 30. It is noted that the web server application and the Majikam™ server can be provided at the same location or at a different location. The uploaded file would then be used in conjunction with the information stored in the database to construct a final web page/video postcard to be sent to the recipient.

The information sent from the Majikam™ server application responsive to the Majikam™ kiosk software would also contain, along with the unique message number, the internet host name of the web server, a user name for log in to the web server, a password for log in to the web server as well as the location in which the document is stored. Once this information is delivered to the sending computer, the digital video file is uploaded to the web server. At this point, the Majikam™ server software sends identification e-mails to the sender and receiver alerting them to the fact that they have a message waiting to be retrieved. The e-mail message sent to the receiver contains a URL link allowing the user to click on the link and to open their message in a web browser. The web browser would open their message and display the video content, along with the text message content and an audio message.

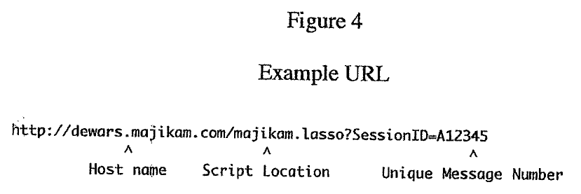

As illustrated in step 30, once the receiver has received their e-mail and clicked on a link, they will be directed to a specified server to retrieve their message. The URL contains the location of the script on the server used to dynamically build the web page as well as the aforementioned unique message number. FIG. 4 illustrates a typical URL link. This link includes the internet host name of the web server, a script location in which to store the document as well as the unique message number. At this point, the web server would send the constructed web page to the receiver as shown by step 32.

While the embodiments described hereinabove are presently the best perceived mode of carrying out the invention, other embodiments may be employed without departing from the scope of the present invention. For example, while the present invention has been described in terms of transmitting a personal e-mail from a sender to a recipient, the present invention could be utilized to produce a web cam database, a security database, a medical database with pictures of patient's conditions as well as a registry of individuals with their associated pictures.

What is claimed is:

1. A system for composing and sending a video e-mail from a sender to a receiver comprising:
a video source for taking a picture;
a first computer connected to said video source for receiving said picture, said computer provided with first software for obtaining information relating to the sender and the receiver;
a centralized web server for receiving and storing said information and said picture from said first computer, said web server provided with second software for communicating with said first computer and the receiver, said web server further provided with a memory for storing said picture in the form of a video e-mail; and
a second computer in communication with said web server, said second computer capable of receiving a communication from said web server indicating that a video e-mail directed to the receiver is stored at said memory of said web server.

2. The system in accordance with claim 1, wherein said second computer includes a means for receiving and displaying the video e-mail received from said web server.

3. The system in accordance with claim 2, wherein said web server constructs a web page including the video e-mail which is transmitted to said second computer and displayed on a web browser provided at said second computer.

4. The system in accordance with claim 1, wherein said picture includes a textual message associated therewith.

5. The system in accordance with claim 3, wherein said picture includes a textual message associated therewith.

6. The system in accordance with claim 1, wherein said picture includes an audio message associated therewith.

7. The system in accordance with claim 3, wherein said picture includes an audio message associated therewith.

8. The system in accordance with claim 1, wherein said first computer has a memory for storing said picture.

9. The system in accordance with claim 8, wherein said first software communicates said information to said second software, and further wherein said second software provides a unique message number to said first software relating to said picture.

10. The system in accordance with claim 9, wherein said picture, said information and said unique message number associated with said digital picture are uploaded to said memory of said web server.

11. The system in accordance with claim 1, wherein said communication received by the receiver from said web server includes a URL.

12. The system in accordance with claim 10, wherein said communication received by the receiver from said web server includes a URL.

13. A system for composing a video e-mail including a picture created by a video source for sending the video e-mail from a server to a receiver comprising:
a centralized web server for receiving and storing said information and said picture from said first computer, said web server provided with second software for communicating with said first computer and the receiver, said web server further provided with a memory for storing said picture in the form of a video e-mail; and
a second computer in communication with said web server, said second computer capable of receiving a communication from said web server indicating that a video e-mail directed to the receiver is stored at said memory of said web server.

14. The system in accordance with claim 13, wherein said second computer includes a means for receiving and displaying the video e-mail received from said web server.

15. The system in accordance with claim 14, wherein said web server constructs a web page including the video e-mail which is transmitted to said second computer and displayed on a web browser provided at said second computer.

16. The system in accordance with claim 13, wherein the picture includes a textual message associated therewith.

17. The system in accordance with claim 15, wherein the picture includes a textual message associated therewith.

18. The system in accordance with claim 13, wherein the picture includes an audio message associated therewith.

19. The system in accordance with claim 15, wherein the picture includes an audio message associated therewith.

20. The system in accordance with claim 13, wherein said first computer has a memory for storing the picture.

21. The system in accordance with claim 20, wherein said first software communicates said information to said second software, and further wherein said second software provides a unique message number to said first software relating to the digital picture.

22. The system in accordance with claim 21, wherein the picture, said information and said unique message number associated with the picture are uploaded to said memory of said web server.

23. The system in accordance with claim 13, wherein said communication received by the receiver from said web server includes a URL.

24. The system in accordance with claim 22, wherein said communication received by the receiver from said web server includes a URL.

25. A method of composing and sending a video e-mail from a sender to a receiver, comprising the steps of:
using a video source to take a picture;
transmitting said picture to a first computer provided with first software for obtaining information relating to the sender and the receiver;
obtaining said information from the sender;
forwarding said information from said first computer to a centralized web server provided with second software for communicating with said first computer and the receiver;
providing a unique message number associated with said information;
sending said unique message number to said first computer to be associated with said picture;
transmitting said digital picture in the form of a video e-mail including said unique message number from said first computer to said web server;
transmitting a message to a second computer indicating that said video e-mail is ready to be delivered to the receiver at said second computer; and
transmitting said video e-mail from said web server to said second computer responsive to a command issued from said second computer to said web server.

26. The method in accordance with claim 25, further including the step of viewing said video e-mail on a web browser provided in said second computer.

27. The method in accordance with claim 26, wherein said video e-mail is constructed in the form of a web page in said server prior to being transmitted to said second computer.

28. The method in accordance with claim 25, further including the step of including a textual message with said picture.

29. The method in accordance with claim 25, further including the step of including an audio message with said picture.

30. The method in accordance with claim 25, further including the step of storing said picture in a memory provided in said first computer.

31. The system in accordance with claim 1, wherein said video source is a digital camera and said picture is a digital picture.

32. The system in accordance with claim 13, wherein the video source is a digital camera and the picture is a digital picture.

33. The method in accordance with claim 25, wherein said video source is a digital camera and said picture is a digital picture.
